(19) United States
(12) Patent Application Publication
(10) Pub. No.: US 2026/0356355 A1
(43) Pub. Date: Nov. 12, 2026

(54) PARKING ASSISTANCE SYSTEM

(71) Applicant: TOYOTA JIDOSHA KABUSHIKI KAISHA, Toyota-shi, Aichi-ken (JP)

(72) Inventors: Tatsuya SUGANO, Seto-shi (JP); Takahiro YAMAMOTO, Toyota-shi (JP); Chenyang WANG, Nagoya-shi (JP)

(73) Assignee: TOYOTA JIDOSHA KABUSHIKI KAISHA, Toyota-shi, Aichi-ken (JP)

(21) Appl. No.: 19/663,563

(22) Filed: Apr. 30, 2026

(30) Foreign Application Priority Data
May 12, 2025 (JP) 2025-079492

(51) Int. Cl. B60W 30/06; G05D 1/223; G05D 1/2285; G05D 107/13; G05D 109/10

(52) U.S. Cl. CPC B60W 30/06; G05D 1/223; G05D 1/2285; B60W 2540/215; G05D 2107/13; G05D 2109/10

(57) ABSTRACT

A parking assistance system performs a first parking assistance control of storing a movement route of a vehicle in a case where a user manually operates the vehicle to enter a parking space or to exit the parking space as a registered route, and causing the vehicle to automatically enter or exit the parking space by causing the vehicle to autonomously drive along the registered route in a case where the vehicle is caused to enter the parking space or to exit parking space in next and subsequent times, and a second parking assistance control of automatically driving the vehicle along a target route in response to an operation of a portable terminal of the user to automatically enter or exit the vehicle into or from the parking space.

### CROSS-REFERENCE TO RELATED APPLICATION

This application claims priority to Japanese Patent Application No. 2025-079492 filed on May 12, 2025. The disclosure of the above-identified application, including the specification, drawings, and claims, is incorporated by reference herein in its entirety.

### BACKGROUND

### 1. Technical Field

The present disclosure relates to a parking assistance system.

### 2. Description of Related Art

A route storage type parking assistance system is known (for example, see Japanese Unexamined Patent Application Publication No. 2024-115676 (JP 2024-115676 A)). In the parking assistance system, a movement route of a vehicle in a case where a user manually operates the vehicle to enter a parking space that is predetermined or to exit the parking space is stored as a registered route. Further, in a case where the vehicle is to be entered into the same parking space or to be exited from the same parking space in next and subsequent times, the vehicle is caused to autonomously drive along the registered route.

### SUMMARY

A so-called remote parking assistance system in which the user remotely operates the vehicle using a portable terminal to enter the vehicle into the parking space that is predetermined or to exit the vehicle from the parking space is known. In a vehicle including such a remote parking assistance system and the above-described route storage type parking assistance system, it is possible to use the registered route stored in the route storage type parking assistance system as a target route of the remote parking assistance system. However, in the remote parking assistance system, since the vehicle travels at a low vehicle speed, in a case where the registered route stored in the route storage type parking assistance system is long, performing remote parking along an entire section of the registered route is not practical. Therefore, in order to improve practicality, switching to remote parking at a point in time after the vehicle has traveled a certain distance by the route storage type parking assistance system is desirable.

The present disclosure has been made to solve the problem, and an object of the present disclosure is to provide a parking assistance system that switches to remote parking assistance at an appropriate timing during execution of parking assistance by the route storage type parking assistance system.

According to a technology of the present disclosure, a parking assistance system is configured to execute a first parking assistance control of storing a movement route of a vehicle in a case where a user manually operates the vehicle to enter a parking space or to exit the parking space as a registered route, and causing the vehicle to automatically enter or exit the parking space by causing the vehicle to autonomously drive along the registered route in a case where the vehicle is caused to enter the parking space or to exit the parking space in next and subsequent times, and a second parking assistance control of causing the vehicle to automatically enter or exit the parking space by causing the vehicle to autonomously drive along a target route in response to an operation of a portable terminal of the user. The parking assistance system is configured to use the registered route as the target route in a case where the vehicle is caused to enter the parking space or to exit the parking space under the second parking assistance control, and switch to execution of the second parking assistance control that uses the registered route in response to a selection by the user in a case where a switching condition that the vehicle stops during execution of the first parking assistance control is satisfied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a hardware configuration of a parking assistance system according to the present embodiment;

FIG. 2 is a schematic diagram showing a software configuration of the parking assistance system according to the present embodiment;

FIG. 3A is a schematic diagram illustrating an example of a movement route according to the present embodiment;

FIG. 3B is a schematic diagram illustrating an example of the movement route according to the present embodiment;

FIG. 4 is a schematic diagram illustrating an example of an overhead image screen according to the present embodiment;

FIG. 5 is a schematic diagram illustrating an example of an in-parking plan selection screen according to the present embodiment;

FIG. 6 is a schematic diagram illustrating an example of a target route during in-parking according to the present embodiment;

FIG. 7 is a schematic diagram illustrating an example of an in-parking plan confirmation screen according to the present embodiment;

FIG. 8 is a schematic diagram illustrating an example of an in-parking operation screen according to the present embodiment;

FIG. 9 is a schematic diagram illustrating an example of an in-parking completion confirmation screen according to the present embodiment;

FIG. 10 is a schematic diagram illustrating an example of a switching proposal screen according to the present embodiment;

FIG. 11 is a schematic diagram illustrating an example of a switching final screen according to the present embodiment;

FIG. 12 is a schematic diagram illustrating an example of a switching plan confirmation screen according to the present embodiment; and

FIG. 13 is a flowchart illustrating a switching process routine according to the present embodiment.

### DETAILED DESCRIPTION OF EMBODIMENTS

Hereinafter, the parking assistance system according to the present embodiment will be described with reference to the drawings.

### Hardware Configuration

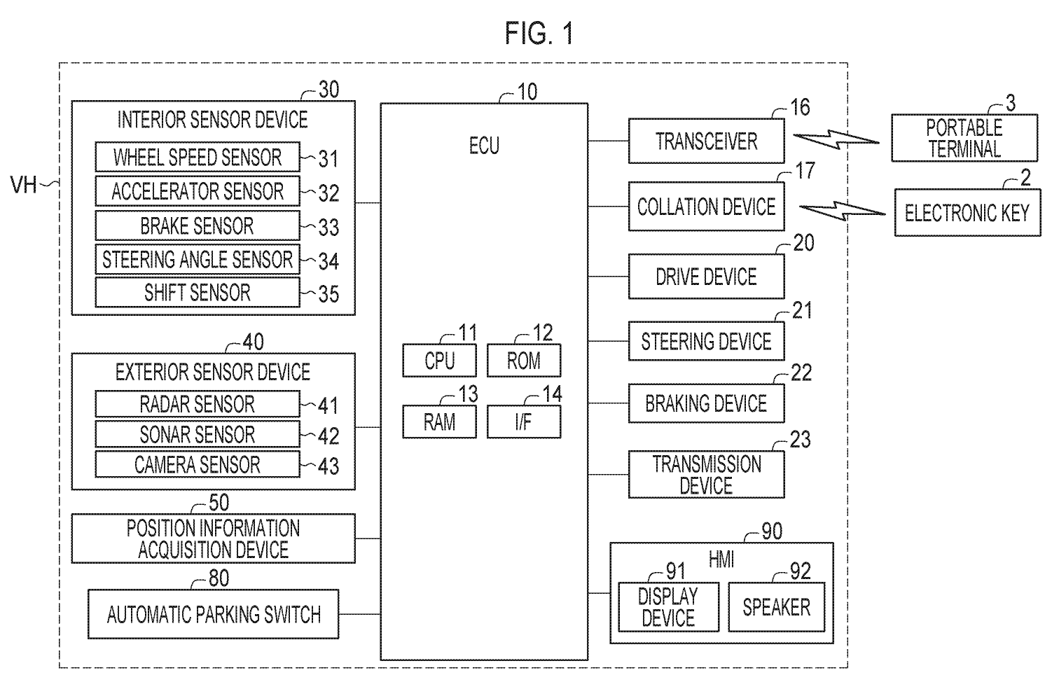

FIG. 1 is a schematic diagram showing a hardware configuration of a parking assistance system according to the present embodiment. As shown in FIG. 1, the parking assistance system includes an electronic control unit (ECU) 10, an electronic key 2, and a portable terminal 3. The ECU 10 is mounted on a vehicle VH. The ECU 10 includes a central processing unit (CPU) 11, a read only memory (ROM) 12, a random access memory (RAM) 13, an interface device 14, and the like. The CPU 11 is a processor that executes various programs stored in the ROM 12. The ROM 12 is a non-volatile memory that stores data and the like necessary for the CPU 11 to execute various programs. The RAM 13 is a volatile memory that provides a work area that is deployed in a case where various programs are executed by the CPU 11. The interface device 14 is a communication device for communicating with an external device.

A transceiver 16, a collation device 17, a drive device 20, a steering device 21, a braking device 22, a transmission device 23, an interior sensor device 30, an exterior sensor device 40, a position information acquisition device 50, an automatic parking switch 80, a human machine interface (HMI) 90, and the like are communicably connected to the ECU 10.

The ECU 10 is a central device that performs automatic in-parking control of automatically parking the vehicle VH in the parking space and automatic out-parking control of automatically parking the vehicle VH from the parking space. Hereinafter, the automatic in-parking control and the automatic out-parking control performed based on the stored registered route are collectively referred to as “route storage parking control”. In addition, the automatic in-parking control and the automatic out-parking control performed by the user by remote operation are collectively referred to as “remote parking control”. The route storage parking control is an example of the first parking assistance control of the present disclosure, and the remote parking control is an example of the second parking assistance control of the present disclosure.

The transceiver 16 is a communication module for performing short-range wireless communication with the portable terminal 3. In the present embodiment, for example, short-range wireless communication via Bluetooth (registered trademark) is performed.

The portable terminal 3 is a device used by the user to remotely operate the vehicle VH, and is possessed by the user. The portable terminal 3 is, for example, a smartphone, but is not limited thereto as long as the terminal can install an application described below, and may be, for example, a tablet terminal. The portable terminal 3 includes an ECU (not shown) and a communication unit that can transmit and receive a Bluetooth (registered trademark) signal.

In order for the user to use the portable terminal 3 as a device for remotely operating the vehicle VH, the following work is performed in advance. Specifically, first, an application for executing the remote parking control is installed on the portable terminal 3 (hereinafter, the application is also referred to as a “remote parking application”). Next, the portable terminal 3 and the vehicle VH are paired (devices corresponding to the Bluetooth (registered trademark) standard are authenticated and connected to each other). Next, the vehicle VH to be operated is registered in the remote parking application. As a result, the portable terminal 3 is associated with the transceiver 16 as a terminal that can perform wireless communication.

The collation device 17 is paired with the electronic key 2, and realizes so-called smart entry by performing wireless communication with the electronic key 2 via, for example, Bluetooth (registered trademark). The electronic key 2 is not limited to the smart key system, and may be a digital key system in which a smartphone possessed by the user is used as a key.

The drive device 20 generates a drive force transmitted to the drive wheels of the vehicle VH. Examples of the drive device 20 include an electric motor and an engine. The steering device 21 applies a steering force to the wheels of the vehicle VH. The braking device 22 applies a braking force to the wheels of the vehicle VH. The transmission device 23 is configured to be selectively switched to a parking P that locks the rotation of the drive wheels, a reverse R that causes the vehicle VH to travel backward, a neutral N that blocks the transmission of power, and a drive D that causes the vehicle VH to travel forward.

The interior sensor device 30 is a sensor that detects a state of the vehicle VH. Specifically, the interior sensor device 30 includes a wheel speed sensor 31, an accelerator sensor 32, a brake sensor 33, a steering angle sensor 34, a shift sensor 35, and the like. The wheel speed sensor 31 detects a traveling speed of the vehicle VH, that is, a vehicle speed. The accelerator sensor 32 detects an operation amount of an accelerator pedal (not shown) by a driver. The brake sensor 33 detects an operation amount of a brake pedal (not shown) by the driver. The steering angle sensor 34 detects a rotation angle of a steering wheel or a steering shaft (not shown), that is, a steering angle. The shift sensor 35 detects a shift position (parking P, reverse R, neutral N, drive D) of the transmission device 23. The interior sensor device 30 transmits the state of the vehicle VH detected by each of the sensors 31 to 35 to the ECU 10 at a predetermined cycle.

The exterior sensor device 40 is a sensor that recognizes object information related to an object around the vehicle VH. Specifically, the exterior sensor device 40 includes a radar sensor 41, a sonar sensor 42, a camera sensor 43, and the like.

The radar sensor 41 includes a millimeter wave radar and/or a lidar. The millimeter wave radar emits radio waves in a millimeter wave band, and receives reflected waves reflected by an object present in a radiation range to acquire a relative distance, a relative speed, and the like between the vehicle VH and the object. The lidar scans a plurality of directions with pulse-shaped laser light having a wavelength shorter than the millimeter wave, and receives reflected light reflected by the object to acquire a shape of the object, a relative distance, a relative speed, and the like between the vehicle VH and the object. The sonar sensor 42 emits ultrasonic waves, and receives reflected waves reflected by an object present in a radiation range to acquire a relative distance, a relative speed, and the like between the vehicle VH and the object. The camera sensor 43 is, for example, a stereo camera or a monocular camera, and a digital camera having an imaging element such as a CMOS or a CCD can be used. The camera sensor 43 acquires a shape of the object, a relative distance, a relative speed, and the like between the vehicle VH and the object by processing captured image data. The exterior sensor device 40 transmits the acquired object information to the ECU 10 at a predetermined cycle. The exterior sensor device 40 does not necessarily include all of the radar sensor 41, the sonar sensor 42, and the camera sensor 43, and may include, for example, only the camera sensor 43.

The position information acquisition device 50 acquires current position information of the vehicle VH. As the position information acquisition device 50, for example, a global positioning system (GPS), a global navigation satellite system (GNSS), or the like provided in a navigation device (not shown) can be used. The position information acquisition device 50 transmits the acquired current position information of the vehicle VH to the ECU 10 at a predetermined cycle.

The automatic parking switch 80 is, for example, a switch that is provided on a center console, an instrument panel, or the like of the vehicle VH and is turned on and off by a user (for example, a driver) of the vehicle VH. In a case where the automatic parking switch 80 is turned on, the ECU 10 receives a parking assistance request from the user. Here, the parking assistance request means, in a case of the route storage parking control, an assistance request for the automatic in-parking control or the automatic out-parking control, and in a case of the remote parking control, an assistance request for the automatic in-parking control. The automatic parking switch 80 is not limited to a physical switch. The automatic parking switch 80 may be a screen display type in which a button displayed on a display device 91 described below is selected by a touch operation or a dial operation. Alternatively, the automatic parking switch 80 may be a voice recognition type in which a voice of the driver is picked up by a voice pickup microphone of the vehicle or the portable terminal 3.

The HMI 90 is an interface for inputting and outputting information between the ECU 10 and the user, and includes an input device and an output device. Examples of the input device include a touch panel, a switch, and a voice pickup microphone. Examples of the output device include a display device 91 and a speaker 92. The display device 91 is, for example, a center display, a multi-information display, a head-up display, or the like. The speaker 92 is, for example, a speaker of an audio system or a navigation system.

### Software Configuration

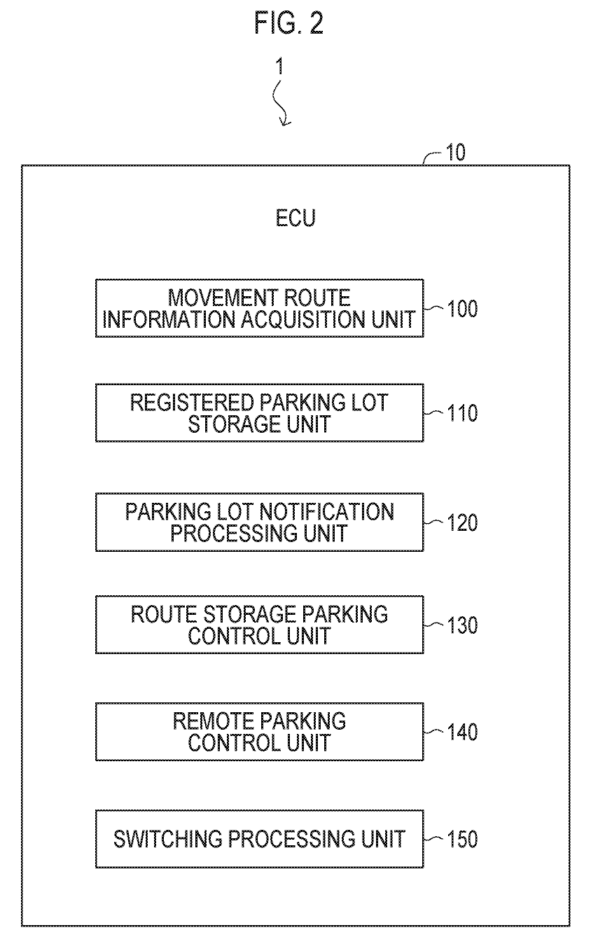

FIG. 2 is a schematic diagram showing a software configuration of the parking assistance system according to the present embodiment. As shown in FIG. 2, the ECU 10 includes a movement route information acquisition unit 100, a registered parking lot storage unit 110, a parking lot notification processing unit 120, a route storage parking controller 130, a remote parking controller 140, and a switching processing unit 150 as functional elements. Each of the functional elements 100 to 150 is realized by the CPU 11 of the ECU 10 reading out and executing a program stored in the ROM 12 in the RAM 13. All or a part of the functional elements 100 to 150 can be provided in another ECU separate from the ECU 10 or in an information processing device of a facility (management center or the like) that can communicate with the vehicle VH.

### Route Storage Parking Control

In a case where a registration start request from a user (for example, a driver) is received, the movement route information acquisition unit 100 acquires movement route information of the vehicle VH in a case where the user manually operates the vehicle VH to enter a predetermined parking space or to exit the predetermined parking space. The movement route information acquisition unit 100 temporarily stores the acquired movement route information in the RAM 13. The registration start request of the user may be acquired by, for example, an operation of a touch-type switch image displayed on the display device 91, an operation of a physical switch provided separately from the display device 91, or voice recognition by a sound collection machine.

The movement route information acquired by the movement route information acquisition unit 100 includes not only the movement route actually traveled by the vehicle VH but also operation information such as a shift position. The movement route of the vehicle VH refers to a movement trajectory of a vehicle position that changes with the traveling of the vehicle VH. The vehicle position is, for example, a predetermined geometric center position of the vehicle VH in a plan view. The vehicle position may be another position (for example, a center position of left and right front wheels or a center position of left and right rear wheels) of the vehicle VH. In a case where the registration start request from the user is received, the movement route information acquisition unit 100 sets the position information of the vehicle VH at that time as a start position of the movement route. The position information of the vehicle VH may be acquired based on a detection result of the position information acquisition device 50. In a case where the start position is set, the movement route information acquisition unit 100 sets, for example, a two-dimensional map in which the start position is an origin, a front-rear direction of the vehicle VH is an X-axis, and a width direction of the vehicle VH is a Y-axis.

In a case where the user starts in-parking or out-parking by manual operation from the start position, the movement route information acquisition unit 100 plots a movement trajectory of the vehicle position on the two-dimensional map for each predetermined sampling cycle. As a result, the movement route of the vehicle VH can be acquired. The movement trajectory may be calculated by, for example, odometry based on a detection result of the wheel speed sensor 31 or the steering angle sensor 34. Alternatively, the movement trajectory may be used in combination with the position information of the vehicle VH acquired by the position information acquisition device 50. Alternatively, the movement trajectory may be estimated from image data of a road surface around the vehicle VH captured by the camera sensor 43 based on optical flow or the like. The predetermined sampling cycle may be any of a predetermined distance or a predetermined time.

In a case of plotting the movement trajectory of the vehicle position on the two-dimensional map, the movement route information acquisition unit 100 acquires the shift position or the like detected by the interior sensor device 30 in association with the vehicle position on the movement route. In a case where the user stops the vehicle VH at a predetermined position and switches the shift position of the transmission device 23 to the parking P, the movement route information acquisition unit 100 ends the acquisition of the movement route information. The movement route information acquisition unit 100 sets the vehicle position at the time of ending the acquisition of the movement route information as an end position of the movement route.

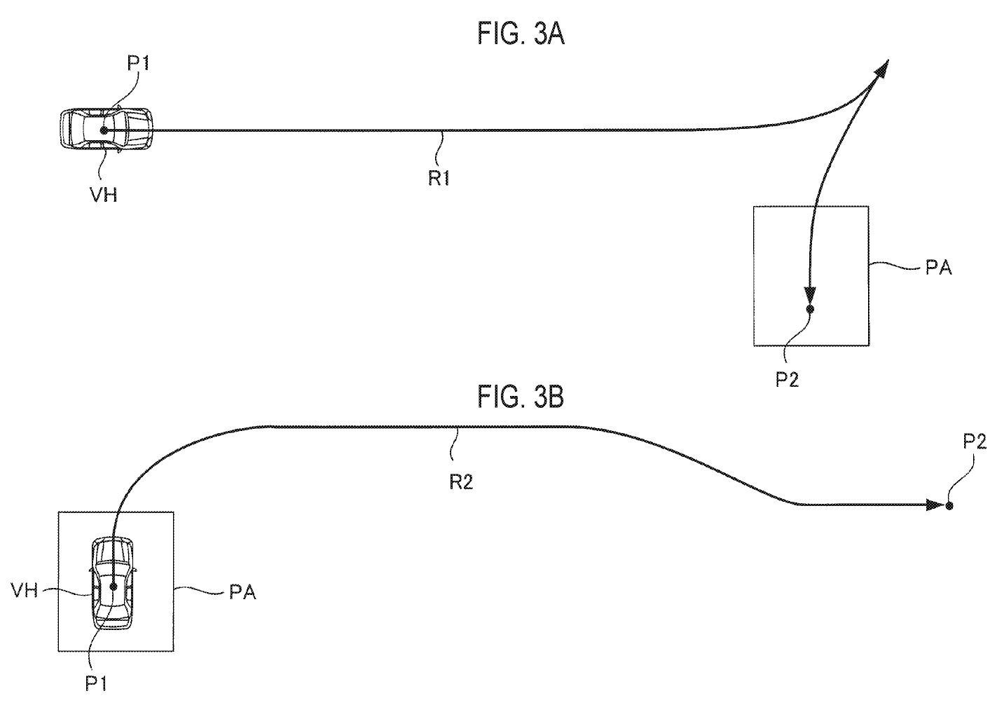

FIGS. 3A and 3B are schematic diagrams illustrating an example of the movement route acquired by the movement route information acquisition unit 100. FIG. 3A is an example of an in-parking movement route R1 acquired by the movement route information acquisition unit 100 in a case where the user parks the vehicle VH in a predetermined parking space PA. FIG. 3B is an example of an out-parking movement route R2 acquired by the movement route information acquisition unit 100 in a case where the user parks the vehicle VH from the predetermined parking space PA. In FIGS. 3A and 3B, reference numeral P1 indicates a start position, and reference numeral P2 indicates an end position.

The registered parking lot storage unit 110 stores the in-parking movement route R1 acquired by the movement route information acquisition unit 100 as an in-parking registered route RT1 used for the route storage parking control. In addition, the registered parking lot storage unit 110 stores the out-parking movement route R2 acquired by the movement route information acquisition unit 100 as an out-parking registered route RT2 used for the route storage parking control. In addition, the registered parking lot storage unit 110 stores the in-parking registered route RT1 and the out-parking registered route RT2 in association with the position information of the parking space PA. The position information of the parking space PA may be acquired based on the detection result of the position information acquisition device 50. In a case where there is a plurality of registered parking lots, the registered parking lot storage unit 110 stores the in-parking registered route RT1, the out-parking registered route RT2, and the like for each registered parking lot. In the present embodiment, the registered parking lot storage unit 110 is configured to store the in-parking registered route RT1 and the out-parking registered route RT2 of a relatively long distance (for example, about 200 m).

In a case where a distance between the current position of the vehicle VH and the registered parking lot is equal to or less than a predetermined distance, the parking lot notification processing unit 120 executes a parking lot notification process of notifying the user of the vehicle VH that the registered parking lot is detected. The current position of the vehicle VH may be acquired based on the detection result of the position information acquisition device 50. The notification to the user may be performed by, for example, displaying on the display device 91 or a voice from the speaker 92.

In a case where the parking lot notification processing unit 120 executes the parking lot notification process and the automatic parking switch 80 is turned on by the user of the vehicle VH, the route storage parking controller 130 executes the route storage parking control of automatically operating the drive device 20, the steering device 21, the braking device 22, and the transmission device 23 of the vehicle VH based on the in-parking registered route RT1 or the out-parking registered route RT2 stored in the registered parking lot storage unit 110. The route storage parking control is executed, for example, by performing feedback control of the operation of the drive device 20, the steering device 21, or the like based on a deviation between the in-parking registered route RT1 or the out-parking registered route RT2 and an actual movement trajectory of the vehicle VH. The actual movement trajectory of the vehicle VH may be calculated by, for example, odometry based on a detection result of the wheel speed sensor 31 or the steering angle sensor 34. Alternatively, the actual movement trajectory of the vehicle VH may be estimated from image data of a road surface around the vehicle VH captured by the camera sensor 43 based on optical flow or the like. In the present embodiment, the route storage parking controller 130 executes the route storage parking control based on a predetermined first target vehicle speed V1 (for example, about 10 km/h).

The route storage parking controller 130 monitors whether there is an object that may come into contact with or collide with the vehicle VH based on the detection result of the exterior sensor device 40 while executing the route storage parking control. In a case where the object that is likely to come into contact with or collide with the vehicle VH is detected, the route storage parking controller 130 decelerates the vehicle VH or interrupts the route storage parking control. In a case where the vehicle VH reaches the end position P2 of the in-parking registered route RT1 or the out-parking registered route RT2, the route storage parking controller 130 stops the vehicle VH. In a case where the shift position of the transmission device 23 is switched to the parking P, the route storage parking controller 130 ends the route storage parking control.

### Remote parking assistance

The remote parking controller 140 executes the remote parking control of causing the vehicle VH to autonomously drive so as to enter a predetermined parking space or to exit the predetermined parking space in a state where the user has gotten out of the vehicle VH. Hereinafter, details of the remote parking control will be described with respect to the remote in-parking control. The parking assistance system can execute the parallel in-parking and the longitudinal in-parking for the remote in-parking control, but the parallel in-parking will be described below, and the longitudinal in-parking will be omitted. In addition, the remote out-parking control is different from the remote in-parking control in which some operations are performed using the display device 91 in that all the operations are performed by the portable terminal 3, but the basic processing is the same, so the description thereof will be omitted.

### Remote In-Parking Control

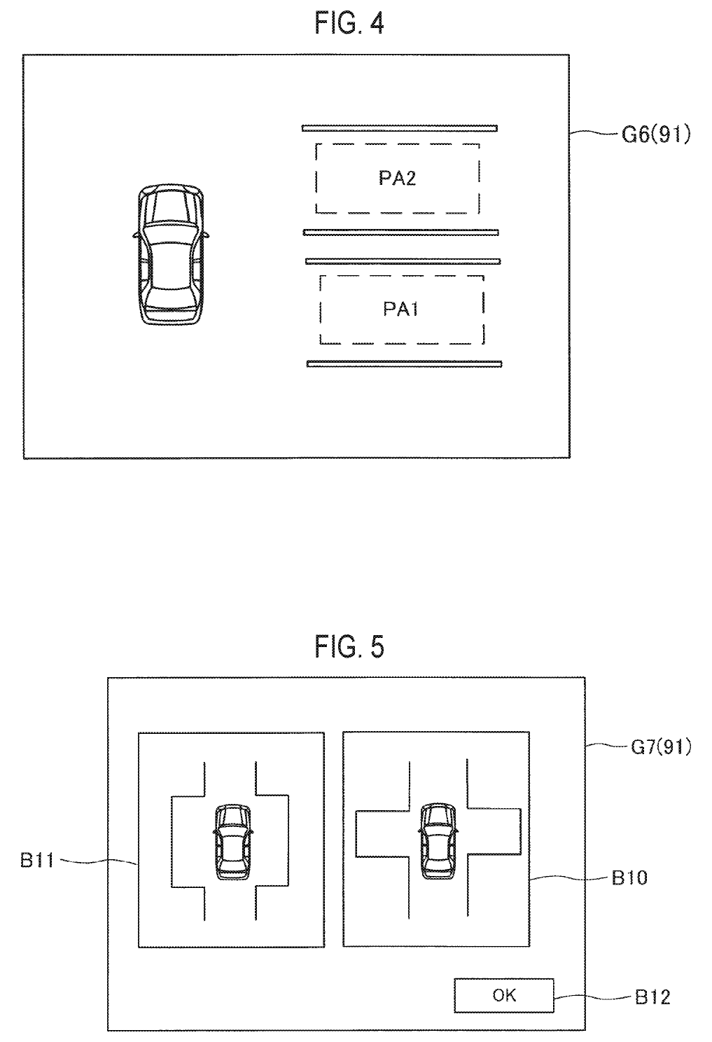

In a case where the user stops the vehicle VH near a desired parking space and then turns on the automatic parking switch 80, the remote parking controller 140 displays an overhead image screen G6 around the vehicle VH generated based on the image data of the camera sensor 43 on the display device 91 as shown in FIG. 4.

In a case where the overhead image screen G6 is displayed, the remote parking controller 140 searches for a parking space (hereinafter, a parkable space) in which the vehicle VH can be parked based on the detection result of the exterior sensor device 40. In addition, in a case where the parkable space is detected, the remote parking controller 140 displays the parkable space on the overhead image screen G6. In the example shown in FIG. 4, two parkable spaces PA1, PA2 are displayed on the overhead image screen G6.

In a case where the user performs a touch operation on the parkable space PA1 of the overhead image screen G6, the remote parking controller 140 sets the parkable space PA1 as a parking space (hereinafter, a designated parking space PAS) in which the user desires to park the vehicle VH. In addition, in a case where the designated parking space PAS is set, the remote parking controller 140 displays an in-parking plan selection screen G7 shown in FIG. 5 on the display device 91. The in-parking plan selection screen G7 includes a parallel in-parking button B10 for parallel in-parking the vehicle VH in the designated parking space PAS, a longitudinal in-parking button B11 for longitudinal in-parking the vehicle VH in the designated parking space PAS, and an in-parking method confirmation button B12 for confirming the in-parking method.

In a case where the user performs a touch operation on the parallel in-parking button B10 and then performs a tap operation on the in-parking method confirmation button B12, the remote parking controller 140 sets the in-parking method of the vehicle VH to the parallel in-parking. In a case where the in-parking method is set, the remote parking controller 140 displays a message (not shown) urging the user to get out of the vehicle on the display device 91.

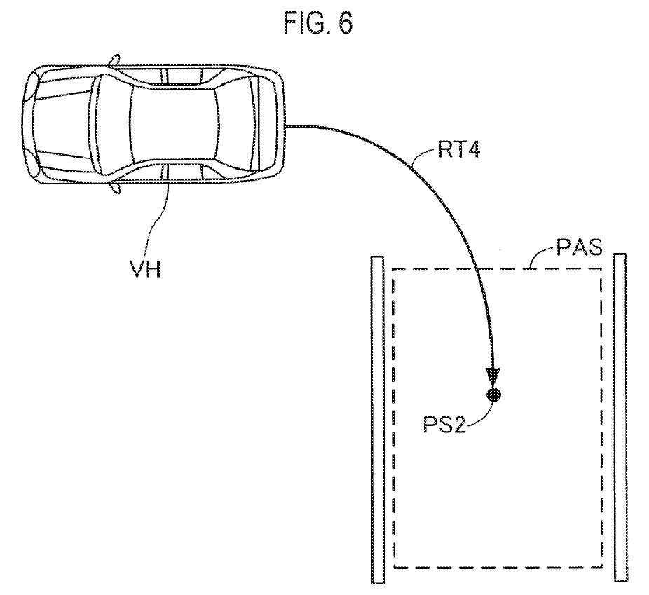

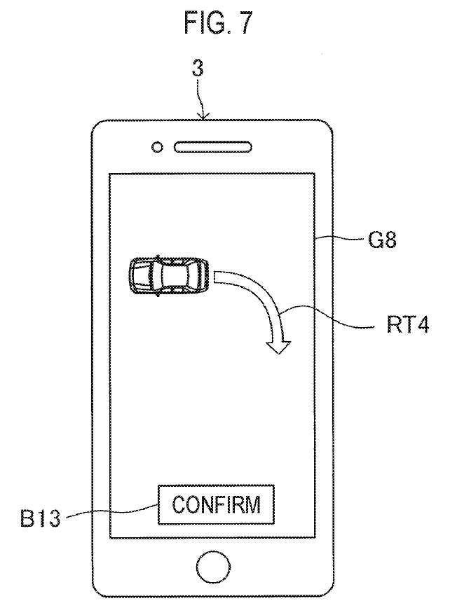

In a case where the user who possesses the electronic key 2 and the portable terminal 3 gets out of the vehicle VH, the remote parking controller 140 sets a target route RT4 for the remote in-parking based on the detection result of the exterior sensor device 40. As shown in FIG. 6, the target route RT4 is a route for causing the vehicle VH to travel to a target stop position PS2 in the designated parking space PAS. In a case where the target route RT4 is set, the remote parking controller 140 displays an in-parking plan confirmation screen G8 shown in FIG. 7 on a display of the portable terminal 3 through the transceiver 16. The in-parking plan confirmation screen G8 includes, for example, the target route RT4 and an in-parking plan confirmation button B13. In a case where the user performs a touch operation on the in-parking plan confirmation button B13, the remote parking controller 140 ends the setting process of the in-parking plan.

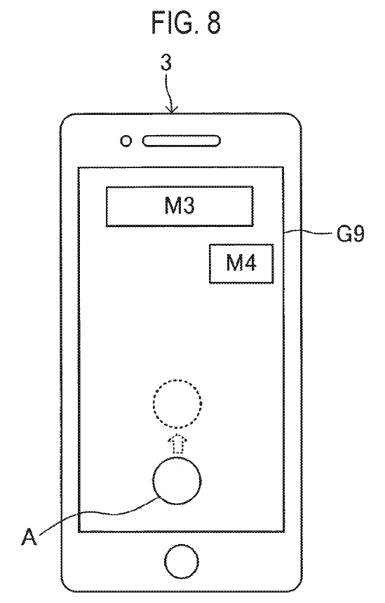

In a case where the setting process of the in-parking plan is ended, the remote parking controller 140 displays an in-parking operation screen G9 shown in FIG. 8 on a display of the portable terminal 3 through the transceiver 16. The in-parking operation screen G9 includes a message M3 to be notified to the user, an operation button A to be operated by the user, and a remaining distance display M4. The remaining distance display M4 is a distance from the current position to the target in-parking stop position PS2 of the vehicle VH.

In a case where the user holds the operation button A displayed on the display of the portable terminal 3 by pressing and holding the operation button A while sliding the operation button A upward on the screen, the remote parking controller 140 controls the operation of the drive device 20, the steering device 21, and the braking device 22 based on the detection results of the interior sensor device 30 and the exterior sensor device 40. As a result, remote in-parking traveling control of causing the vehicle VH to autonomously drive along the target route RT4 is started. In a case where the user separates a finger from the display of the portable terminal 3 during the execution of the remote in-parking traveling control, the remote parking controller 140 interrupts the remote in-parking traveling control.

In a case where the remote in-parking traveling control is started, the remote parking controller 140 sequentially calculates the movement trajectory. In addition, the remote parking controller 140 calculates the remaining distance until the vehicle VH reaches the target in-parking stop position PS2 based on the movement trajectory sequentially calculated during the execution of the remote in-parking traveling control, and displays the remaining distance on the remaining distance display M4. The movement trajectory may be calculated by, for example, odometry based on a detection result of the wheel speed sensor 31 or the steering angle sensor 34. Alternatively, the movement trajectory may be estimated from image data of a road surface around the vehicle VH captured by the camera sensor 43 based on optical flow or the like. In the present embodiment, the remote parking controller 140 executes the remote in-parking traveling control based on a predetermined second target vehicle speed V2 (for example, about 5 km/h) that is slower than the first target vehicle speed V1.

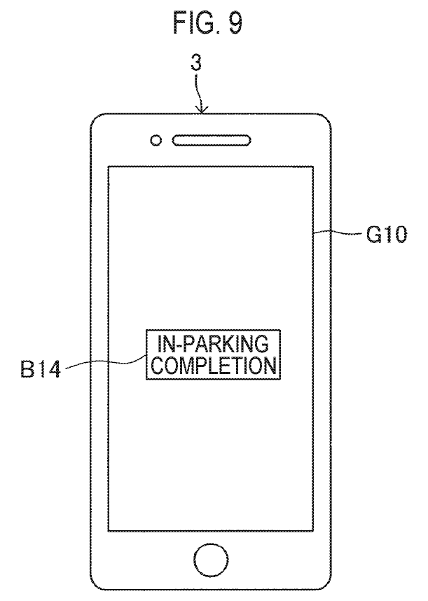

The remote parking controller 140 determines whether the vehicle VH has reached the target stop position PS2 based on the movement trajectory sequentially calculated during the execution of the remote in-parking traveling control. In a case where it is determined that the vehicle VH has reached the target stop position PS2, the remote parking controller 140 displays an in-parking completion confirmation screen G10 shown in FIG. 9 on a display of the portable terminal 3 through the transceiver 16. The in-parking completion confirmation screen G10 includes an in-parking completion button B14. In a case where the user performs a touch operation on the in-parking completion button B14, the remote parking controller 140 ends the remote in-parking control.

### Switching Processing Unit

The switching processing unit 150 determines whether any one of a first switching condition (1) or a second switching condition (2) is satisfied during the execution of the route storage parking control by the route storage parking controller 130.

(1) The remaining distance from the current position of the vehicle VH to the end position P2 of the route storage parking control is equal to or less than a predetermined remaining distance threshold value D1.

(2) The distance between the vehicle VH and the peripheral obstacle is equal to or less than a predetermined lower limit threshold value D2 as the vehicle VH approaches the peripheral obstacle.

The current position of the vehicle VH may be acquired based on the detection result of the position information acquisition device 50. The remaining distance threshold value D1 is not particularly limited. The remaining distance threshold value D1 may be set to a distance shorter than the maximum distance (for example, about 200 m) that can be stored as the in-parking registered route RT1 or the out-parking registered route RT2 in the registered parking lot storage unit 110, based on a distance (for example, about 100 m) suitable for the user to in-park and out-park the vehicle VH by the remote parking assistance. The distance between the vehicle VH and the peripheral obstacle may be acquired based on the detection result of the exterior sensor device 40. The lower limit threshold value D2 is not particularly limited, but may be set based on a distance (for example, several m) at which the user feels that the clearance with the obstacle is desired to be visually checked after the user gets out of the vehicle VH.

In a case where any one of the first switching condition (1) or the second switching condition (2) is satisfied, the switching processing unit 150 determines whether the following third switching condition (3) is satisfied.

(3) The vehicle VH is stopped by the brake operation of the user.

The brake operation of the user may be acquired based on the detection result of the brake sensor 33. Whether the vehicle VH is stopped may be acquired based on the detection result of the wheel speed sensor 31.

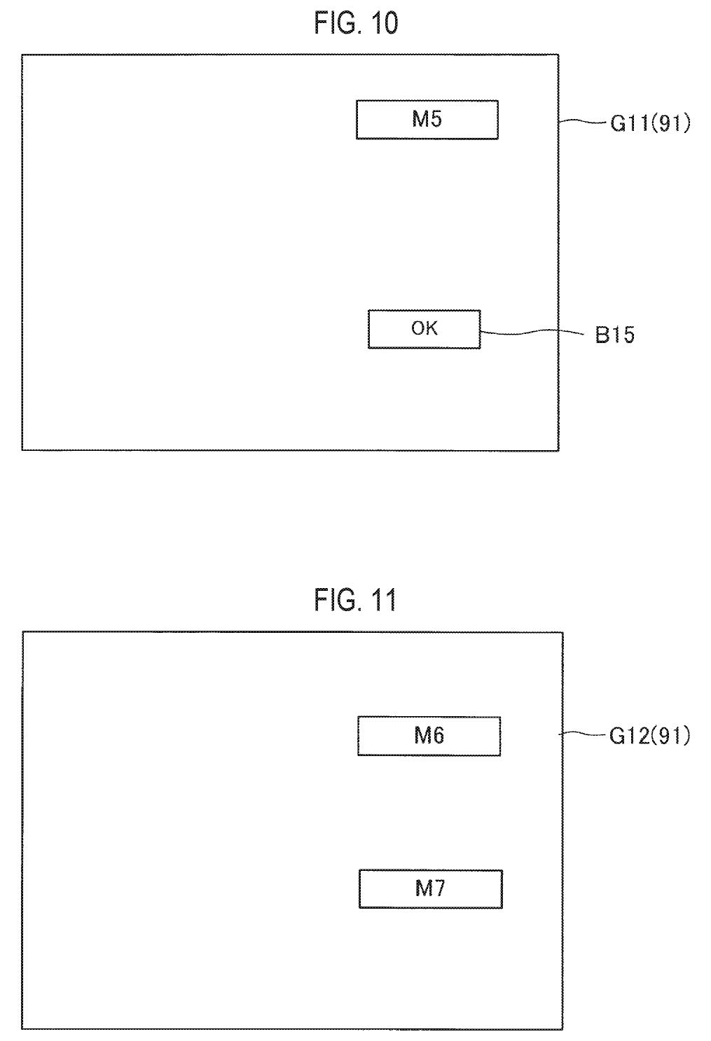

In a case where the third switching condition (3) is satisfied, the switching processing unit 150 displays a switching proposal screen G11 shown in FIG. 10 on the display device 91. The switching proposal screen G11 includes a message M5 to be notified to the user and a remote switching button B15. As the message M5, for example, a sentence such as “Do you want to switch to the remote parking assistance?” is displayed. The switching processing unit 150 may perform the proposal by voice from the speaker 92 at the same time in a case of displaying the switching proposal screen G11 on the display device 91. Alternatively, the proposal may be performed by voice only.

In a case where the user performs a touch operation on the remote switching button B15, the switching processing unit 150 switches the shift position of the transmission device 23 to the parking P. In a case where the transmission device 23 is switched to the parking P, the switching processing unit 150 displays a switching final screen G12 shown in FIG. 11 on the display device 91. The switching final screen G12 includes a message M6 to urge the user to get out of the vehicle and a message M7 to urge the user to start the remote parking application of the portable terminal 3.

In a case where the switching final screen G12 is displayed on the display device 91, the user gets out of the vehicle VH, and the remote parking application of the portable terminal 3 is started, the switching processing unit 150 executes the switching process of ending the route storage parking control by the route storage parking controller 130 and starting the remote parking control by the remote parking controller 140. Hereinafter, a specific flow of the switching process will be described with the remote in-parking control as an example. Since the flow for the remote out-parking control is basically the same, the description thereof will be omitted.

The switching processing unit 150 acquires, as the switching process, first the current position of the vehicle VH and the in-parking registered route RT1 used by the route storage parking controller 130 for the route storage parking control. In addition, in a case where the current position of the vehicle VH and the in-parking registered route RT1 are acquired, the switching processing unit 150 sets a route from the current position of the vehicle VH in the in-parking registered route RT1 to the end position P2 as a target route (hereinafter, referred to as a switched remote target route RT4’) used by the remote parking controller 140 for the remote in-parking control.

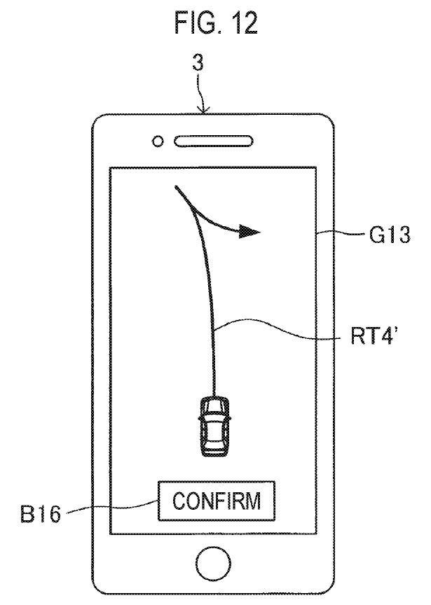

In a case where the switched remote target route RT4’ is set, the switching processing unit 150 displays a switching plan confirmation screen G13 shown in FIG. 12 on a display of the portable terminal 3 through the transceiver 16. The switching plan confirmation screen G13 includes, for example, the switched remote target route RT4’ and a switching plan confirmation button B16. In a case where the user performs a touch operation on the switching plan confirmation button B16, the remote parking controller 140 starts the remote in-parking control of causing the vehicle VH to autonomously drive along the switched remote target route RT4’. The flow of the subsequent remote in-parking control is as described above with reference to FIGS. 8 and 9.

According to the present embodiment described above, in a case where any one of the first switching condition (1) in which the remaining distance to the end position P2 is equal to or less than the predetermined remaining distance threshold value D1 or the second switching condition (2) in which the distance between the vehicle VH and the peripheral obstacle is equal to or less than the predetermined lower limit threshold value D2 is satisfied during the execution of the route storage parking control, a proposal to switch from the route storage parking control to the remote parking control is made. In a case where the user accepts the proposal, the switching to the remote parking control is performed. That is, the entire section of the in-parking registered route RT1 or the out-parking registered route RT2 is not performed by the remote parking control with a slow vehicle speed, and the switching to the remote parking is performed at a point in time when the remaining distance to the end position P2 is sufficiently shortened or the peripheral obstacle is close. As a result, for example, in a region where the surrounding space is relatively wide, the route storage parking control with a fast vehicle speed can be executed, and in a region where the surrounding space is relatively narrow, the switching to the remote parking control with a slow vehicle speed can be performed. As described above, it is possible to effectively improve the practicality.

In addition, according to the present embodiment, in a case where the third switching condition (3) in which the vehicle VH is stopped by the brake operation of the user is satisfied in addition to the satisfaction of the first switching condition (1) or the second switching condition (2), a proposal to switch from the route storage parking control to the remote parking control is made. That is, the proposal is made at a point in time when the user stops the vehicle VH, instead of at a point in time when the user stops the vehicle VH and switches the shift position of the transmission device 23 to the parking P. As a result, for example, in a situation where the user desires to stop the parking assistance by switching the shift position of the transmission device 23 to the parking P, it is possible to prevent the switching proposal to the remote parking control. That is, it is possible to effectively prevent the user from being bothered by unnecessary switching proposals.

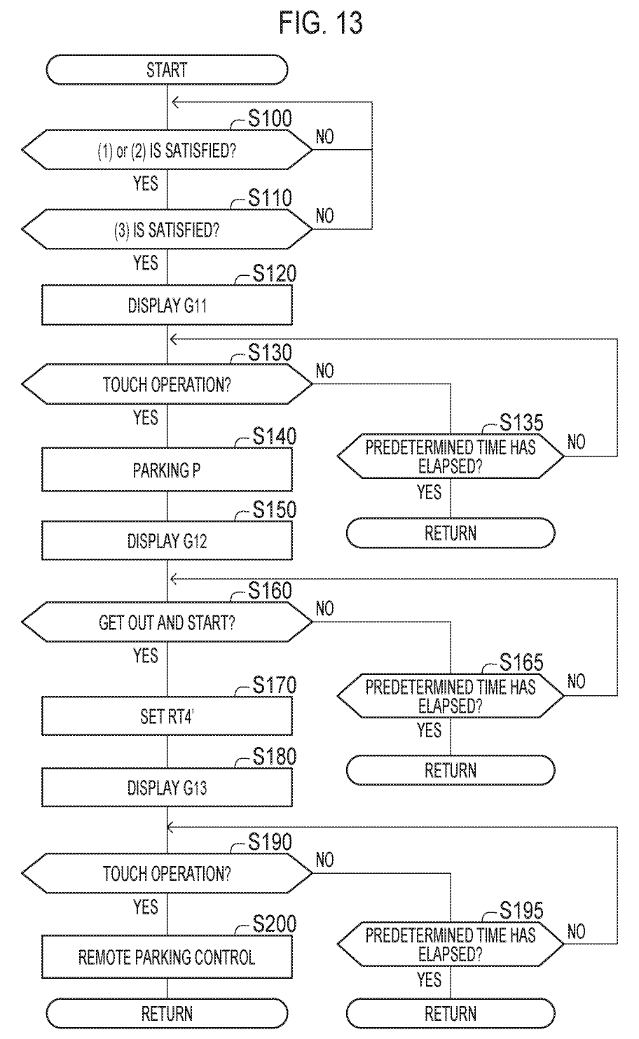

Next, a routine of the switching process executed by the CPU 11 of the ECU 10 will be described with reference to the flowchart shown in FIG. 13. The present routine is started in a case where the route storage parking control is executed.

In S100, the ECU 10 determines whether any one of the first switching condition (1) or the second switching condition (2) is satisfied. In a case where any one of the first switching condition (1) or the second switching condition (2) is satisfied (Yes), the ECU 10 proceeds to the processing of S110. On the other hand, in a case where neither the first switching condition (1) nor the second switching condition (2) is satisfied (No), the ECU 10 returns to the processing of S100.

In S110, the ECU 10 determines whether the third switching condition (3) is satisfied. In a case where the third switching condition (3) is satisfied (Yes), the ECU 10 proceeds to the processing of S120. On the other hand, in a case where the third switching condition (3) is not satisfied (No), the ECU 10 returns to the processing of S100.

In S120, the ECU 10 displays the switching proposal screen G11 (see FIG. 10) on the display device 91. Next, in S130, the ECU 10 determines whether the user has performed a touch operation on the remote switching button B15 of the switching proposal screen G11. In a case where the user has performed a touch operation on the remote switching button B15 (Yes), the ECU 10 proceeds to the processing of S140. On the other hand, in a case where the user has not performed a touch operation on the remote switching button B15 (No), the ECU 10 proceeds to the processing of S135. In S135, the ECU 10 determines whether a predetermined time has elapsed from the display of the switching proposal screen G11. In a case where the predetermined time has elapsed (Yes), the ECU 10 returns from the present routine. On the other hand, in a case where the predetermined time has not elapsed (No), the ECU 10 returns to the processing of S130.

In S140, the ECU 10 switches the shift position of the transmission device 23 to the parking P. Next, in S150, the ECU 10 displays the switching final screen G12 (see FIG. 11) on the display device 91.

In S160, the ECU 10 determines whether the user has gotten out of the vehicle VH and started the remote parking application of the portable terminal 3. In a case where the user has not gotten out of the vehicle VH or has not started the remote parking application of the portable terminal 3 (No), the ECU 10 proceeds to the processing of S165. In S165, the ECU 10 determines whether a predetermined time has elapsed from the display of the switching final screen G12. In a case where the predetermined time has elapsed (Yes), the ECU 10 returns from the present routine. On the other hand, in a case where the predetermined time has not elapsed (No), the ECU 10 returns to the processing of S160.

In a case where it is determined in S160 that the user has gotten out of the vehicle VH and started the remote parking application of the portable terminal 3 (Yes), the ECU 10 proceeds to the processing of S170. In S170, the ECU 10 sets the switched remote target route RT4’ used for the remote parking control.

In S180, the ECU 10 displays the switching plan confirmation screen G13 (see FIG. 12) on the display of the portable terminal 3. Next, in S190, the ECU 10 determines whether the user has performed a touch operation on the switching plan confirmation button B16 of the switching plan confirmation screen G13. In a case where the user has performed a touch operation on the switching plan confirmation button B16 (Yes), the ECU 10 proceeds to the processing of S200. The remote parking control of causing the vehicle VH to autonomously drive along the switched remote target route RT4’ is executed, and then the present routine is returned. On the other hand, in a case where the user has not performed a touch operation on the switching plan confirmation button B16 (No), the ECU 10 proceeds to the processing of S195. In S195, the ECU 10 determines whether a predetermined time has elapsed from the display of the switching plan confirmation screen G13. In a case where the predetermined time has elapsed (Yes), the ECU 10 returns from the present routine. On the other hand, in a case where the predetermined time has not elapsed (No), the ECU 10 returns to the processing of S190.

The present disclosure is not limited to the above-described embodiment, and various modifications can be made without departing from the object of the present disclosure.

For example, in the above-described embodiment, the switching proposal to the remote parking control has been described as being made in a case where any one of the first switching condition (1) or the second switching condition (2) is satisfied and the third switching condition (3) is satisfied. However, the switching proposal can also be configured to be made in a case where only the third switching condition (3) is satisfied or

in a case where the third switching condition (3) is not satisfied but any one of the first switching condition (1) or the second switching condition (2) is satisfied. In addition, in the above-described embodiment, the switching proposal to the remote parking control has been described. However, the switching can also be configured to be performed without the switching proposal, in a case where any one of the first switching condition (1) or the second switching condition (2) is satisfied and the third switching condition (3) is satisfied, in response to the selection of the user. In addition, the third switching condition (3) may be satisfied in a case where the exterior sensor device 40 detects the shutter closure of the parking lot or the like during the execution of the route storage parking control and the vehicle VH is automatically stopped in front of the parking lot or in a case where the vehicle VH is automatically stopped in front of the parking lot for a U-turn. In addition, in a case where the registered parking lot storage unit 110 is configured to store the vehicle speed together with the in-parking registered route RT1 and the out-parking registered route RT2 and execute the route storage parking control based on the stored vehicle speed, the switching proposal to the remote parking control can also be configured to be made in a region where the vehicle VH travels at a predetermined vehicle speed (for example, the second target vehicle speed V2) or less by the route storage parking control.

What is claimed is:

1. A parking assistance system configured to execute:
a first parking assistance control of
(i) storing a movement route of a vehicle in a case where a user manually operates the vehicle to enter a parking space or to exit the parking space as a registered route, and
(ii) causing the vehicle to automatically enter or exit the parking space by causing the vehicle to autonomously drive along the registered route in a case where the vehicle is caused to enter the parking space or to exit the parking space in next and subsequent times; and
a second parking assistance control of causing the vehicle to automatically enter or exit the parking space by causing the vehicle to autonomously drive along a target route in response to an operation of a portable terminal of the user, wherein:
the parking assistance system is configured to
use the registered route as the target route in a case where the vehicle is caused to enter the parking space or to exit the parking space under the second parking assistance control, and
switch to execution of the second parking assistance control that uses the registered route in response to a selection by the user in a case where a switching condition that the vehicle stops during execution of the first parking assistance control is satisfied.

2. The parking assistance system according to claim 1, wherein, in the case where the switching condition is satisfied, a proposal to switch to the second parking assistance control is made to the user by a screen display or voice, or both, and, in a case where the user selects switching to the second parking assistance control, the parking assistance system switches to the execution of the second parking assistance control that uses the registered route.

3. The parking assistance system according to claim 1, wherein the switching condition is satisfied in a case where the vehicle stops by a brake operation of the user during the execution of the first parking assistance control.

4. The parking assistance system according to claim 1, wherein the switching condition is satisfied in a case where a remaining distance from a current position of the vehicle to a target end position of the first parking assistance control is equal to or less than a predetermined remaining distance threshold value during the execution of the first parking assistance control.

5. The parking assistance system according to claim 1, wherein the switching condition is satisfied in a case where a distance between the vehicle and a peripheral obstacle is equal to or less than a predetermined threshold value during the execution of the first parking assistance control.
